(19) United States
(12) Patent Application Publication
(10) Pub. No.: US 2025/0158083 A1
(43) Pub. Date: May 15, 2025

(54) PROCESS FOR PRODUCING A DEVICE FOR USE IN FILTRATION, CHEMICAL PROCESSES OR ELECTROCHEMICAL PROCESSES COMPRISING A POROUS LAYER AND A SUPPORTING LAYER AND DEVICE OBTAINABLE BY THE PROCESS

(71) Applicants: Headmade Materials GmbH, Unterpleichfeld (DE); Element22 GmbH, Kiel (DE)

(72) Inventors: Christian STAUDIGEL, Unterpleichfeld (DE); Christian FISCHER, Unterpleichfeld (DE); Matthias SCHARVOGEL, Hamburg (DE); Johannes Geronimo SCHAPER, Dannewerk (DE); Wendelin WINKELMÜLLER, Kiel (DE); Florian GERDTS, Kiel (DE); Markus LANG, Kiel (DE)

(21) Appl. No.: 18/874,873

(22) PCT Filed: Jun. 16, 2023
(86) PCT No.: PCT/EP2023/066251

§ 371 Date: Dec. 13, 2024

(30) Foreign Application Priority Data
Jun. 17, 2022 (EP) 22179587.5

(51) Int. Cl. H01M 4/92; C25B 1/04; C25B 11/031; C25B 11/036; C25B 11/081; C25B 13/05; H01M 4/88; H01M 8/0245

(52) U.S. Cl. CPC H01M 4/92; C25B 11/031; C25B 11/036; C25B 11/081; C25B 13/05; H01M 4/8885; H01M 8/0245; C25B 1/04

(57) ABSTRACT

A process for producing a device for use in filtration, chemical processes or electrochemical processes is described, the device comprising a porous layer and a supporting layer comprising channels running in the plane of the supporting layer and being open towards the porous layer. The process comprises providing a stack comprising a) the porous layer, or a green part of the porous layer which green part contains a sinterable material powder and a binder, or a partially debound green part of the porous layer, and b) a green part of the supporting layer. The process further comprises the green part of the supporting layer being applied on the porous layer or the green part of the porous layer or the partially debound green part of the porous layer by additive manufacturing from a sinterable material powder and a binder in a layer-by-layer wise manner; sintering the green parts; and thermally bonding the stack. The process allows for producing devices having a structure that is optimized with regard to current flow, reactant flow and resistance to pressure differentials, and for producing the devices in an economical way.

Process for producing a device for use in filtration, chemical processes or electrochemical processes comprising a porous layer and a supporting layer and device obtainable by the process

The present invention relates to a process for producing a device for use in filtration, chemical processes, or electrochemical processes, in particular an electrode useful in an electrolyzer, such as a PEM-type electrolyzer, in a fuel cell, in a power-to-liquid reactor, in a gas to liquid reactor or in a power to gas reactor, and a device obtainable by the process.

In 2020, the worldwide hydrogen demand was about 90 Mt, with more than 70 Mt used as pure hydrogen and less than 20 Mt mixed with carbon-containing gases in methanol production and steel manufacturing. Almost all this demand was for refining and industrial uses. Currently, hydrogen is still produced mainly from fossil fuels, resulting in about 900 Mt of CO₂ emissions per year. In view of reducing the carbon footprint, it is therefore important to develop and establish technologies which allow for producing green hydrogen.

For example, one way to produce environmentally friendly hydrogen is PEM electrolysis. One component of a PEM electrolyzer is a proton exchange membrane (PEM), which is contacted on both sides by porous electrodes coated with a catalytic layer, e.g., made of platinum or iridium. Inside a PEM electrolyzer, two separate water circuits are realized, namely an anode-side water circuit and a cathode-side water circuit. An external voltage is applied to the electrodes and water is supplied to the anode side of the electrolyzer. Through the catalytic effect, e.g. of the platinum, the water on the anode side is split. This produces oxygen, free electrons and positively charged protons (hydrogen ions H⁺). The protons diffuse through the proton exchange membrane to the cathode side, where they combine with the electrons from the external circuit to form hydrogen molecules H₂.

Individual cells may be combined into assemblies, to provide the efficacy required.

The operation environment and the requirements for its components such as bipolar plates, supporting layer and porous metal layer are determined by the properties of electrolyte membrane and the electrolyzer cell/stack operation conditions. Hence, the following example illustrates embodiments of the invention, but the invention is not limited to these embodiments.

PEM electrolyzers typically operate at high pressure, either on cathode (hydrogen electrode for hydrogen evolution reactions) or on anode (oxygen electrode for oxygen evolution reactions). In reversible fuel cell systems, both anode and cathode chambers are at high pressure. Therefore, all components, including bipolar plates, must have sufficient mechanical strength to withhold the pressure. In particular, in cells that may be exposed to high differential pressures, the low-pressure side of the membrane must be supported by a relatively incompressible supporting layer.

The proton exchange membrane is sandwiched between two porous transport layers (PTL), in order to transport the reactant, e.g., water onto the catalyzers and onto the PEM and to transport the reaction products away again. Furthermore, the porous transport layers also have an electrical function, i.e., to lead a current as large as possible onto the catalyzers on the cell membrane over a large surface. Moreover, the surface of the PTL must be very smooth in order to avoid damage of the catalyst layer or membrane during operation.

For electrical reasons, the electrically conductive surface contacting the PEM, PTL inclusive of the supporting structure, and the supporting layer should be as dense as possible to ensure an intensive and uniform flow of current over an available surface area. With regard to the reactant feed and the reaction product discharge, a structure having open pores would be useful in order to allow for reactant flow through the respective products with as little energy effort as possible. On the other hand, such porous transport layers should be as thin as possible. This allows for a large number of electrochemical cells to be arranged in a cell stack of a given stack height.

In order to fulfil the aforementioned demands, for example, it is known to support a thin, porous layer that contacts the PEM by sheets of expanded metals. Such expanded metals are in the form of metal sheets which have been cut and stretched to form a regular pattern of metal mesh-like material. Stacks of expanded metal sheets with varying mesh size are typically employed. A common disadvantage of stacks of expanded metal sheets are their poorly defined contact points, even if the expanded metal sheets are welded together in order to produce the stack. Such poorly defined contact points are unfavorable as they, for example, result in unreliable electrical conductivity.

Alternatively, non-wovens, felts or fabrics of a small thickness may be used which are formed from titanium fibers and to then provide these with a porous titanium layer.

US 2021/0164109 A1 describes a method for manufacturing a porous transport layer of an electrochemical cell. The method comprises mixing a metal powder with a binder and a subsequent shaping-out into a foil. The foil is brought to bear on a porous metal layer. The binder is subsequently removed, and the remaining brown part layer is sintered to the porous metal layer, so that a porous transport layer is formed. Said porous transport layer includes a porous metal layer with a microporous metal layer deposited on the porous metal layer.

There is an ongoing need for devices having a structure that is further optimized with regard to current flow, reactant flow and resistance to pressure differentials, and which are produced in an economical way.

The object of the present invention is solved by a process for producing a device for use in filtration, chemical processes or electrochemical processes comprising a porous layer and a supporting layer comprising channels running in the plane of the supporting layer and being open towards the porous layer, the process comprising
providing a stack comprising
   a) the porous layer, or a green part of the porous layer which green part contains a sinterable material powder and a binder, or a partially debound green part of the porous layer, and
   b) a green part of the supporting layer,
the green part of the supporting layer being applied on the porous layer or the green part of the porous layer or the partially debound green part of the porous layer by additive manufacturing from a sinterable material powder and a binder in a layer-by-layer wise manner,
sintering the green parts, and
thermally bonding the stack.

If the device produced according to the invention is intended for use in an electrochemical process, the porous layer is a porous metal layer.

If the device produced according to the invention is intended for use in an electrochemical process, the sinterable material powder generally is an electrically conductive sinterable material powder. After debinding and sintering, an electrically conductive solid structure made of the electrically conductive sinterable material is obtained with a porosity only resulting from the sintering porosity.

In an embodiment, the device is an electrode useful in an electrolyzer, preferably a PEM-type electrolyzer, in a fuel cell, in a power-to-liquid reactor, in a gas-to-liquid reactor or in a power-to-gas reactor, wherein the porous layer is a porous metal layer,
the device additionally comprising a bipolar plate facing the surface of the supporting layer opposite the porous metal layer, the stack additionally comprising
   c) the bipolar plate, or a green part of the bipolar plate which green part contains a metal powder and a binder.

In the electrode, the porous metal layer and/or the supporting layer and/or the bipolar plate is made of an electrically conductive material powder such as a metal. For example, the metal of the porous metal layer and/or the supporting layer and/or the bipolar plate is a) titanium or a titanium alloy, b) nickel or a nickel alloy, c) iron or an iron alloy, or d) carbon.

The present invention envisages additive manufacture of a green part of the supporting layer from a sinterable material powder and a binder. This allows manufacture of a supporting layer with a controlled architecture meaning that the structure in the layer or at least a portion thereof is as designed rather than random.

The porosity of the supporting layer can be controlled in two ways.

First, the supporting layer is characterized by “geometrical porosity” (also referred to as “structural porosity” or “inter-strut porosity”) which is determined by channels/passageways (voids) and the dense structural elements such as pillars, columns, grids or struts. The geometrical porosity is defined as the ratio of all open volumes or physical gaps to the total volume occupied by the open volumes and physical gaps and structural elements. Therein, the structural elements are assumed to be idealized massive bodies defined by their outer contour not taking into consideration the sintering porosity defined below. The geometrical porosity is usually implemented in the electronic or computerized construction process of the part, i.e. by the CAD design of the part.

The geometrical porosity usually refers to open volumes or physical gaps with dimensions above 100 μm, preferably above 200 μm, more preferably above 300 μm, most preferably above 400 μm, in particular above 500 μm.

Second, the supporting layer is characterized by “sintering porosity” (also referred to as “intra-strut porosity”) within the structural elements themselves. Sintering porosity can be controlled by the parameters of additive manufacturing and sintering. These parameters include the particle size distribution of the sinterable material powder, the binder content, the 3D printing parameters, the sintering parameters etc.

The sintering porosity usually refers to pores with dimensions below 500 μm, preferably below 400 μm, more preferably below 300 μm, most preferably below 200 μm, in particular below 100 μm. Preferably, the sintering porosity is above 0 vol.-%, preferably above 1 vol.-%, more preferably above 2 vol.-%, most preferably above 3 vol.-%, in particular above 4 vol.-%, in particular above 5 vol.-%, in particular above 6 vol.-%, and below 70 vol.-%, preferably below 65 vol.-%, more preferably below 60 vol.-%, most preferably below 55 vol.-%, in particular below 50 vol.-%, in particular below 45 vol.-%.

Hence, control of properties at different locations within the layer, to produce for example passageways or channels with a gradient of the opening ratio through the layer is made possible. The architecture may also be ordered meaning that it is also regular or periodic at least in one direction through at least part of the layer, or having a predetermined orientation relative to the external shape of the layer. The designed structure can refer to the channels as well as to the integral structure of the supporting layer.

Moreover, control of properties at different locations within the layer, to produce for example the integral structure or a finite element method (FEM) optimized model of the supporting layer is made possible. This allows an optimization of current flow and of mass transport in the in-plane direction in addition to that in the through-plane direction.

The method further enables a supporting layer with a controlled porous architecture including both geometrical porosity and sintering porosity. Hence, control of properties at different locations within the element, to produce for example regions of different porosity through the element is a desired feature. The porosity may also be ordered meaning that it is also regular or periodic at least in one direction if not in two, three or more directions through at least part of the element, or having a predetermined orientation relative to the external shape of the element.

Generally, the porosity, including both geometrical porosity and sintering porosity, is interconnected meaning that at least a major fraction or substantially all open volumes or pores intersect with at least some other open volumes or pores which extend in a different direction. This can optimize the flow of the reactants and/or products through the supporting layer and the mechanical stability of the supporting layer.

Methods have been known comprising the steps of computationally designing a product including a controlled fluid permeable architecture and producing a three dimensional positive model of the product from an electronic or computerized data file using additive manufacturing, also referred to as layered manufacturing or 3-dimensional printing technology.

The supporting layer, also referred to as “gas diffusion layer”, serves various functions. First, the supporting layer must ensure reactant feed and the reaction product discharge to and from the PEM via the porous metal layer. Second, the supporting layer serves to mechanically support the porous metal layer. Third, the supporting layer connects the porous metal layer and bipolar plate mechanically and electrically.

The process allows for a supporting layer that has a geometrical porosity characterized by a non-uniform opening ratio in a direction perpendicular to the plane of the supporting layer. The opening ratio is defined as the ratio of the open area of a cross-section of the layer to the total area of the cross-section. Open area is defined as the area that is not occupied by a structural element, e.g. designed in CAD. Frequently, the opening ratio at the surface facing the porous metal layer is smaller than the opening ratio at a distance from the porous metal layer. This allows for better support of the porous metal layer and better electrical dissipation of the electric current away from the porous metal layer.

Similarly, the opening ratio of the supporting layer may increase in a normal direction from the porous metal layer to a middle plane of the supporting layer. But, also other variations are possible.

The method further enables a supporting layer having a non-uniform geometrical porosity in at least one direction parallel to the plane of the supporting layer. An example thereof is a supporting layer with a gradient geometrical porosity which is substantially ordered in one direction or two directions parallel to the plane of the supporting layer by at least a part of the layer, meaning that it is substantially regular or periodic in one direction or two directions parallel to the plane of the supporting layer, but the order has a gradient in one direction or two directions parallel to the plane of the supporting layer. In other words, the structural elements that are repeatedly arranged and that define the ordered structure vary slightly among each other to form a gradient in at least one direction of the supporting layer. This can optimize the flow of the reactants and reaction products through the supporting layer, taking into account the fact that, for example, in an electrolyzer the reactant is a liquid and the reaction products form a liquid-gas mixture.

In an embodiment, the bipolar plate comprises passageways running in the plane of the bipolar plate and being open towards the porous metal layer. Hence, the passageways allow for an efficient flow of reactants and gases, which are further distributed through or collected and withdrawn from the supporting layer. The passageways may be parallel such as a series of corrugations or in a serpentine pattern.

In an embodiment, the supporting layer has a generally grid-like structure with grid webs and grid nodes. The grid webs form passageways. The grid webs may be tilted with respect to the plane of the supporting layer to form passageways. The passageways allow for a flow of reactants and gases through the supporting layer in a direction parallel to the plane of the supporting layer.

In order to enhance the mechanical contact and electrical conductivity as well as a load-optimized design of the supporting layer to the porous metal layer, the grid may have conical or trumpet-shaped widenings (flare portion) at the points of contact with the porous metal layer. In some embodiments, the points of contact with the porous metal layer coincide with grid nodes.

The structural elements such as pillars, columns, grids or struts, constituting the supporting layer may have a non-uniform sintering porosity, e.g. a gradient sintering porosity, in a direction perpendicular to the plane of the supporting layer.

To ensure reactant feed and the reaction product discharge the points of contact might have a higher porosity then the rest of the supporting layer, i.e. a gradient sintering porosity is implemented. For example, for symmetrical conical or trumpet-shaped widenings, the sintering porosity can decrease with decreasing cross section in the direction perpendicular to the supporting layer until a neck portion of symmetrical conical or trumpet-shaped widening and increase again after the neck portion, so that the sintering porosity is lowest in the neck portion. Herein, the term “neck portion” is intended to denote a region of the smallest cross section. In such a way, the electrical conductivity can be kept constant with varying cross section of the widenings.

In another example, the sintering porosity is kept low beyond the neck portion to keep electrical resistance low. The electrical resistance can be kept at a minimum and the flow of the reactants and/or products can be optimized where necessary.

By “green part” is meant a bound shaped part comprised of a sinterable material powder and an organic binder. In a post-processing step, the binder is removed and the sinterable material powder sintered. Sintering corresponds to the thermal consolidation of the metal material. It is usually accompanied by a decrease in porosity and dimensional shrinkage.

“Thermal bonding” means the thermal joining or laminating of layers, optionally with the application of a joining force. Thermal bonding includes, for example, welding, resistance welding, ultrasonic welding, friction welding, or soldering. Preferably, the thermal bonding is carried out without requiring adhesives. This creates a strong bond at the interface between thermally bonded portions. In certain embodiments of the process, thermal bonding intrinsically occurs simultaneously with sintering, when a stack of two or three layers as described herein is sintered together.

The porous layers serves to transport the reactant, e.g. water, onto the PEM and to transport the reaction products away again. Such transport is basically achieved by capillary function of the material featuring open pores of small dimensions.

Generally, the thickness of the porous layer is above 0.01 mm, preferably above 0.05 mm, more preferably above 0.08 mm, most preferably above 0.1 mm. Generally, the thickness of the porous layer is below 2 mm, preferably below 1 mm, more preferably below 0.7 mm, most preferably below 0.5 mm. Generally, the thickness of the porous layer is in the range of from 0.01 to 2 mm, preferably 0.05 to 1 mm, more preferably 0.08 to 0.7 mm, most preferably 0.1 to 0.5 mm.

Suitably, the geometrical porosity of the porous layer is above 30 vol.-%, preferably above 40 vol.-%, more preferably above 45 vol.-%, most preferably above 50 vol.-%. Suitably, the geometrical porosity of the porous layer is below 80 vol.-%, preferably below 70 vol.-%, more preferably below 65 vol.-%, most preferably below 60 vol.-%. Suitably, the geometrical porosity of the porous layer is in the range of from 30 to 80 vol.-%, preferably 40 to 70 vol.-%, more preferably 45 to 65 vol.-%, most preferably 50 to 60 vol.-%. The pores are interconnected and have an open porosity. The porosity including geometrical porosity and sintering porosity can be measured, e.g. by computed tomography (CT) analysis.

Generally, the thickness of the supporting layer is above 0.5 mm, preferably above 0.8 mm, more preferably above 1 mm, most preferably above 1.5 mm. Generally, the thickness of the supporting layer is below 5 mm, preferably below 4 mm, more preferably below 3 mm, most preferably below 2.5 mm. Generally, the thickness of the supporting layer is in the range of from 0.5 to 5 mm, preferably 0.8 to 4 mm, more preferably 1 to 3 mm, most preferably 1.5 to 2.5 mm.

Generally, the thickness of the bipolar plate is above 0.5 mm, preferably above 0.8 mm, more preferably above 1 mm, most preferably above 1.5 mm. Generally, the thickness of the bipolar plate is below 5 mm, preferably below 4 mm, more preferably below 3 mm, most preferably below 2.5 mm. Generally, the thickness of the bipolar plate is in the range of from 0.5 to 5 mm, preferably 0.8 to 4 mm, more preferably 1 to 3 mm, most preferably 1.5 to 2.5 mm. Most preferably, the bipolar plate is fluid-tight. It is understood that the term “bipolar plate” also encompasses a monopolar endplate of an assembly. The bipolar plate should have high electrical conductivity as an ohmic loss in the plate will reduce the overall assembly efficiency. Mostly, bipolar plates are made of metal.

The bipolar plate and/or supporting layer may be provided with surface features such as surface textures, which ensure essentially even distribution of reactants and gases over the electrode surfaces.

Designs of the supporting layer which are optimized with regard to reactant or gas flow, mechanical or electrical connection may comprise design features which are not attainable by conventional processes, such as undercuts. The term “undercut” denotes a design element that protrudes freely on molded parts and would prevent said parts from being demolded from the cavity. Such undercuts cannot be produced directly using conventional manufacturing techniques for parts such as injection molding but require producing the part in at least two pieces which subsequently require bonding the pieces to form an integral part. The production of the supporting layer via additive manufacturing is not subject to constraints imposed by conventional processes. Hence, the supporting layer may comprise undercuts with respect to a direction normal to the plane of the supporting layer to form the passageways.

The structure of the supporting layer is subject to variation. In the following, selected embodiments are described in more detail.

In an embodiment, the supporting layer comprises individual pillars or columns spaced from each other, having an axis being perpendicular to the plane of the supporting layer. In order to improve mechanical and electrical contact to the adjacent layers, i.e. to the porous metal layer and/or the bipolar plate, the columns preferably have conical or trumpet-shaped widenings on either side. If the columns have conical or trumpet-shaped widenings on both sides, hourglass-shaped columns are formed. For example, for symmetrical conical or trumpet-shaped widenings, the sintering porosity can decrease with decreasing cross section in the direction perpendicular to the supporting layer until a neck portion of the pillar or column and increase again after the neck portion, so that the sintering porosity is lowest in the neck portion.

Suitably, the connection between the supporting layer and the porous metal layer and/or the bipolar plate is rounded or smooth and preferably, does not involve acute or right angles. Hence, preferably, a tangent on the surface of the supporting layer close to the surface of the porous metal layer makes an angle with said surface of the porous metal layer that is larger than 120°, in particular larger than 130°.

Preferably, the sintering porosity of the conical or trumpet-shaped widening which contacts the porous metal layer is higher compared to the sleeker part of the column, e.g. at the middle plane of the supporting layer. This allows for reactants and reaction products to pass through the porous regions and intensifies the contact of the reactants and reaction products with the porous metal layer but also allows a uniform current flow and current density.

In an embodiment, the column comprises a central recess in the region of the conical or trumpet-shaped widening so that a closed cavity is formed that is limited by the column and the porous metal layer. In an embodiment, the closed cavity is approximately conical. By providing the recess, the wall thickness is reduced which the reactants and reaction products have to pass in order to get into contact with the porous metal layer.

In order to improve mechanic stability of the supporting layer, in particular the stability of the green part from which the supporting layer is formed, the individual columns are interconnected. Said interconnection may occur by connecting braces which join neighboring columns. The connecting braces are preferably tilted with respect to the plane of the supporting layer to form passageways between the connecting braces and the underneath surface. Preferably, the connecting braces are angled or curved so that they may compensate mechanical stress which occurs during sintering, in particular in the event that the supporting layer and the porous metal layer and/or the bipolar plate exhibit different degree of shrinking.

Alternatively, the supporting layer comprises essentially parallel ribs spaced from each other so that channels are formed which are confined by the ribs, the bipolar plate and the porous metal layer.

The channels run across the supporting layer from one side to the other, i.e. have a first opening at the side face of the supporting layer and a second opening at the side face of the supporting layer. In order to improve mechanical and electrical contact to the adjacent layers, i.e. to the porous metal layer and/or the bipolar plate, the ribs preferably widen on either side. This may result in the flow cross section of the passageway being round.

The channels may have a height in a direction perpendicular to the plane of the supporting layer and/or the bipolar plate above 0.5 mm, preferably above 0.8 mm, more preferably above 1 mm, most preferably above 1.5 mm. The channels may have a height in a direction perpendicular to the plane of the supporting layer and/or the bipolar plate below 5 mm, preferably below 4 mm, more preferably below 3 mm, most preferably below 2.5 mm. The channels may have a height in a direction perpendicular to the plane of the supporting layer and/or the bipolar plate in the range of from 0.5 to 5 mm, preferably 0.8 to 4 mm, more preferably 1 to 3 mm, most preferably 1.5 to 2.5 mm.

In an embodiment, the channels are straight, single-curved or multi-curved.

The device produced in accordance with the invention comprises, in addition to the supporting layer, a porous metal layer. The process can involve the use of a pre-fabricated porous metal layer or, in the alternative, a green part of the porous metal layer, or a partially debound green part of the porous layer.

Manufacture of a green part of the porous metal layer involves the mixing of a sinterable material powder with a binder and forming the mixture into a sheet-like shape. In an embodiment, the green part of the porous metal layer is formed into a sheet-like shape by an extrusion process, a layer-by-layer wise manner process, a casting process, or a calendering process.

In one embodiment, the process of the invention comprises applying the green part of the supporting layer on the green part of the porous layer or the partially debound green part of the porous layer by additive manufacturing from a sinterable material powder and a binder so as to produce an integral part jointly formed of the green part of the supporting layer and the green part of the porous layer. To this end, the green part of the porous layer or the partially debound green part of the porous layer is placed in the build chamber of a 3-dimensional printing device and the green part of the supporting layer is 3-dimensionally printed directly on the green part of the porous metal layer. Alternatively, the green part of the porous metal layer can be printed in the printing device and the supporting layer is printed directly on the green part of the porous metal layer. Subsequently, the green parts and/or partially debound green parts (hereinafter also referred to as “brown part(s)”) can be debound and sintered together.

Alternatively, the green part of the supporting layer is applied on the porous layer by additive manufacturing. Subsequently, the stack is subjected to debinding and sintering. Care should be taken during debinding and sintering so that the quality of the joint between the supporting layer and the porous metal layer is not affected by excessive shrinkage of the green part of the supporting layer.

### Additive Manufacturing

According to the invention, a green part of the supporting layer is additively manufactured from a sinterable material powder and a binder.

By such additive manufacturing processes, the green part is manufactured in a layer-by-layer wise manner. Herein, the term “layer-by-layer” denotes that a first layer of the green part is manufactured, followed by one or more further layers.

Such additive manufacturing processes may either use pre-formed compound particles containing a sinterable material powder and a binder. Alternatively, the additive manufacturing processes may use sinterable material powder, wherein the binder is selectively deposited to the sinterable material powder during the process. Some additive manufacturing processes may use both pre-formed compound particles containing a sinterable material powder and a binder, and further binder or solvent may be selectively deposited.

Alternatively, the additive manufacturing process may either use pre-formed filaments or granules or slurry in an extrusion based process containing a sinterable material powder and a binder. Alternatively, the additive manufacturing process may either use a slurry containing a sinterable material powder and a binder.

In an embodiment, the additive manufacturing process comprises the steps of: providing compound particles containing a sinterable material powder and a binder;
providing a first layer of compound particles;
selectively merging the first layer of compound particles to bind the compound particles to each other in a predefined manner so as to produce a first shaped part layer,
optionally, providing at least one further layer of compound particles on the first shaped part layer;
selectively merging the further layer of compound particles to bind the compound particles to each other in a predefined manner so as to produce at least one further shaped part layer, the first shaped part layer and the further shaped part layers forming a green part.

“Selectively merging” means that the compound particles are bound to each other in a target area, with substantially no particle bonding outside the target area. Selective merging can be accomplished by known methods of additive manufacturing. Selective merging may involve selectively melting the binder, e.g. by means of electromagnetic radiation, and/or dissolving the binder in a fluid that is selectively deposited on a compound particle layer.

Selectively merging the first and further layer of compound particles may involve
(i) selectively irradiating at least one of the first or the at least one further layer with electromagnetic radiation, generally referred to as laser sintering (LS), or
(ii) selectively depositing a functional agent, e.g. a fusing agent and/or a detailing agent, and exposing the whole first or at least one further layer to radiation, generally referred to as multi jet fusion (MJF) or High Speed Sintering (HSS), or
(iii) selectively applying a patterning agent, generally referred to as binder jetting (BJ).

The molten or dissolved binder becomes distributed between the sinterable material powder particles and holds these together after solidification, so that a comparatively strong shaped part is formed.

For example, in a process for (i), a first layer of compound particles is provided, for example as a powder bed in a construction space, and the first layer is selectively merged. For this purpose, the construction space is positioned in a horizontal x direction and a horizontal y direction relative to the electromagnetic radiation. To apply a second layer, the construction space is positioned in a vertical z direction relative to an application direction of the compound particles. After application of the second layer on top of the first layer, the second layer is once again selectively merged. For this purpose, the construction space is positioned in the x direction and the y direction relative to the electromagnetic radiation.

Further layers are applied and selectively merged in a manner analogous to applying and selectively merging the second layer, until the desired shape part has been produced.

The layers are applied by means of an application device to a construction base body or a previously applied layer. The application device is, for example, configured as a doctor blade and/or roller.

Generally, the shaping step of laser sintering (LS) processes involves providing a powder bed of a compound particles in a construction space which is usually heated to an elevated temperature, e.g. to 50 to 60° C. The compound particles in the powder bed can absorb the energy, e.g., from an energy beam from a radiation source, such as a laser beam, and as a result, a localized region of the powder material increases in temperature. The local increase in temperature allows for selectively melting the compound particles to bind the compound particles to each other in a predefined manner.

In particular, selectively irradiating with electromagnetic radiation involves directing an electromagnetic radiation beam on the first and the at least one further layer and moving said electromagnetic radiation beam over the layers.

To implement a gradient sintering porosity the energy input can be locally varied. Variation of the energy input by electromagnetic radiation over portions of the first and the at least one further layer may be accomplished by varying the power of the electromagnetic radiation beam and/or speed of movement and/or hatch distance of the electromagnetic radiation beam over the layers.

Generally, in a process for (ii), such as a multi jet fusion or high speed sintering process, an entire layer of compound particles is exposed to radiation, such as infrared radiation, but a selected region of the layer is fused and hardened to become a shaped part layer. A functional agent, e.g. a fusing agent and/or a detailing agent, is selectively deposited in contact with the selected region of the particle layer. For this purpose, the construction space is positioned in a horizontal x direction and a horizontal y direction relative to an applicator of the fluid. To apply a second layer, the construction space is positioned in a vertical z direction relative to an application direction of the compound particles. After application of the second layer on top of the first layer, the second layer is once again selectively merged. For this purpose, the construction space is positioned in the x direction and the y direction relative to the applicator of the fluid.

The functional agent(s) are capable of penetrating into the layer of compound particles and spreading onto the exterior surface of the compound particles. The fusing agent is capable of absorbing radiation and converting the absorbed radiation to thermal energy, which in turn melts or sinters the compound particles that are in contact with the fusing agent. The detailing agent is capable of reflecting radiation and/or reduce the conversion of the absorbed radiation to thermal energy and/or cooling the compound particles, which in turn does not melt or sinter the compound particles that are in contact with the detailing agent. This causes the compound particles to fuse, bind, cure, etc. selectively to form the shaped part layer.

Further layers are applied and selectively merged in a manner analogous to applying and selectively merging the second layer, until the desired shape part has been produced.

The layers are applied by means of an application device to a construction base body or a previously applied layer. For example, the application device is configured as a doctor blade and/or roller.

Generally, the shaping step of multi jet fusion (MJF) processes involves providing a powder bed of a compound particles in a construction space which is usually heated to an elevated temperature, e.g. to 50 to 60° C. The functional agents, e.g. a fusing agent and/or a detailing agent, is applied. The compound particles with fusing agent in the powder bed can absorb the energy, e.g., an energy from a radiation source, such as an infrared radiation, and as a result, a localized region of the powder material increases in temperature. The local increase in temperature allows for selectively melting the compound particles to bind the compound particles to each other in a predefined manner.

The compound particles in the powder bed wetted with detailing agent can reflect the energy and/or absorb less energy, e.g., from a radiation source, such as an infrared radiation. Alternatively or additionally, the detailing agent can effectively cool the compound particles. As a result, the temperature increase in a localized region of the powder material is limited. The limited lower local temperature increase allows for selectively protecting the compound particles from melting and to maintain the compound particles as a powder bed.

Generally, in a process according to (iii), such as a binder jetting process, a patterning agent is selectively applied to a layer of compound particles. The binder of the compound particles is selected so that it is at least partially soluble in a patterning agent that is used during printing. Dissolution of the binder physically breaks up the compound particles and converts them into layer of thick slurry of the sinterable material powder. The slurry is a layer of adequate structural uniformity that is composed of the sinterable material powder, which can be merged as a result of binder dissolution and redistribution, fluid evaporation, and capillary forces to form a merged green part.

Further layers are applied and selectively merged in a manner analogous to applying and selectively merging the second layer, until the desired shape part has been produced.

The layers are applied by means of an application device to a construction base body or a previously applied layer. The application device is, for example, configured as a doctor blade and/or roller.

Generally, the shaping step of binderjetting (BJ) processes involves providing a powder bed of a compound particles in a construction space which is usually heated to an elevated temperature, e.g. to 30 to 80° C. The compound particles in the powder bed can absorb the patterning agent and the binder is at least partially soluble in a patterning agent. As a result, in a localized region of the powder material, the dissolution of the binder physically breaks up the compound particles and converts them into a layer of thick slurry of the sinterable material powder. The local dissolution of the binder allows for selectively breaking up the compound particles to bind the compound particles to each other in a predefined manner.

In particular, selectively applying a patterning agent involves applying a patterning agent on the first and the at least one further layer whereby the amount and/or composition of the patterning agent is locally varied.

Alternatively, the additive manufacturing processes may use sinterable material powder, wherein the binder is selectively deposited to the sinterable material powder during the process.

Hence, in an embodiment, the process comprises the steps of providing a first layer of sinterable material powder;
selectively depositing a binder liquid onto the first layer of sinterable material powder to bind the sinterable material powder together in a predefined manner so as to produce a first shaped part layer,
providing at least one further layer of sinterable material powder on the first shaped part layer;
selectively depositing the binder liquid onto the further layer of sinterable material powder to bind the sinterable material powder together in a predefined manner so as to produce at least one further shaped part layer, the first shaped part layer and the further shaped part layers forming a green part.

Said process may be referred to as “binder jetting process initially using uncompounded sinterable material powder”. In contrast thereto, the binder jetting process (iii) as described above utilizes compound particles containing the sinterable material powder and the binder.

In said “binder jetting process initially using uncompounded sinterable material powder”, the first layer is provided from sinterable material powder without binder. The binder is added to said first layer in the form of a binder liquid. The binder liquid is a mixture of the binder and a liquid, e.g. a solvent which allows for dissolving the binder. For example, the liquid may be selected from water or organic solvents such as alcohols, ketones or aldehydes.

Further layers are applied and selectively merged in a manner analogous to applying and selectively merging the second layer, until the desired shape part has been produced.

The layers are applied by means of an application device to a construction base body or a previously applied layer. The application device is, for example, configured as a doctor blade and/or roller.

Generally, the shaping step of binder jetting (BJ) processes involves providing a powder bed of an uncompounded sinterable material powder in a construction space which is usually heated to an elevated temperature, e.g. to 30 to 80° C. The uncompounded sinterable material powder in the powder bed can absorb the binder liquid, and as a result, in a localized region the binder liquid converts the powder material into layer of thick slurry of the sinterable material powder. The local application of the binder liquid allows for selectively binding the uncompounded sinterable material powder to each other in a predefined manner.

In the processes (i) to (iii), a non-uniform sintering porosity, e.g. a gradient sintering porosity, can be attained by the following measures or combinations thereof.

To implement gradient sintering porosity, the process comprises the further steps of defining a desired three-dimensional porosity field of the element and programming the composition and/or amount of patterning agent for the two-dimensional coordinates of the first and the at least one further layer.

In an embodiment, the process comprises
providing a first type of compound particles having a first volume concentration of sinterable material powder and a second type of compound particles having a second volume concentration of sinterable material powder,
at least a portion of the first or further layers comprises the first type of compound particles and at least a portion of the first or further layers comprises the second type of compound particles. In addition to the first type and second type of compound particles, further type(s) of compound particles may be provided, at least a portion of the first or further layers comprises the further type(s) of compound particles.

In an embodiment, the process comprises
providing a first type of compound particles having a first average particle size of sinterable material powder and a second type of compound particles having a second average particle size of sinterable material powder,
at least a portion of the first or further layers comprises the first type of compound particles and at least a portion of the first or further layers comprises the second type of compound particles.

In an embodiment, the process comprises incorporation of flux agents or flux-reducing agents. Flux agents or flux-reducing agents are agents that increase or decrease sintering activity of the sinterable material powder. Flux agents or flux-reducing agents can enhance or inhibit grain growth and diffusion processes during sintering. The suitability and efficacy of flux agents or flux-reducing agents is strongly dependent on the sinterable material powder.

In an embodiment, the process comprises
providing a first type of compound particles having a first volume concentration of flux agent and a second type of compound particles having a second volume concentration of flux agent or no flux agent,
at least a portion of the first or further layers comprises the first type of compound particles and at least a portion of the first or further layers comprises the second type of compound particles.

In an embodiment, the process comprises selectively applying a flux agent or flux-reducing agent to a first and/or further layer of compound particles, wherein to at least a portion of the first or further layers, the flux agent or flux-reducing agent is applied in a first concentration, and to at least a portion of the first or further layers, no flux agent or flux-reducing agent is applied or the flux agent or flux-reducing agent is applied in a concentration different from the first concentration.

Flux agents and flux-reducing agents are dependent on the sinterable material powder. Suitable flux agents may be selected from fine particles, e.g. nanoparticles, of sinterable material. For stainless steel 316L, carbon or boron may be suitable flux agents. For metals, suitable flux-reducing agents may be selected from ceramics such as oxides or carbides.

Alternatively, the additive manufacturing processes may use sinterable material powder and binder in an extrusion additive manufacturing process in form of filament, granule, paste or slurry. Generally, an extrusion additive manufacturing process is a process in which a feedstock compound is fed as filament or granule, is melted in a heated printer extruder head, and is deposited layer-wise to build up a green part. Alternatively the feedstock compound is fed as slurry or a paste in a printer extruder head, and is deposited layer-wise to build up a green part. The print head is moved under computer control to define the printed shape. Usually, the head moves in two dimensions to deposit one horizontal plane, or layer, at a time; the work or the print head is then moved vertically by a small amount to begin a new layer. After the printing process, the shaped feedstock compound can be removed as a solidified green part. The green part comprises the sinterable non-organic powder particles and the binder.

To implement a gradient sintering porosity, the extrusion strategy and distance between the extrusion lines may vary.

Alternatively, the additive manufacturing processes may use sinterable material powder and binder in form of filled resins or pastes as in lithography based technologies. In addition to sinterable material powder and organic components, the resin or paste contains a photoinitiator, which hardens under radiation or light, preferably ultraviolet radiation. The resin or paste is applied with a squeegee as a thin layer in the air-conditioned build room. This is then selectively exposed to a radiation source, preferably a UV lamp. Then layer after layer is further applied and treated under UV light. When the component or components have been built up, the parts are removed from the build chamber. In an embodiment, the material in the build chamber is solid at room temperature and is heated with warm air so that the unexposed paste melts and only the solid, exposed green part or parts remain. The green part comprises the sinterable non-organic powder particles and the binder.

Alternatively, the additive manufacturing processes may use sinterable material powder and binder in form of a slurry or a paste as in mold slurry deposition. First, the mold is produced in one layer as a negative of the component geometry from a wax-like polymer with so-called inkjet print heads. This printed layer of mold material is then filled with material powder paste via a slotted nozzle and a squeegee. Then layer after layer is further applied. The printed green part is solid or solidified by supported of heat and/or radiation for hardening, curing or drying.

After the printing process, the shaped feedstock compound can be removed as a solidified green part from the wax mold, e.g. by heat. The green part comprises the sinterable non-organic powder particles and the binder.

### Sinterable Material Powder

The sinterable material powder includes conventionally known sinterable materials. In general, the sinterable material powder are selected from metals, alloys, vitreous particles and ceramic particles.

If the device produced according to the invention is intended for use in an electrochemical process, the sinterable material powder, specifically the sinterable material powder contained in the green part(s) that give rise to the porous layer and/or the supporting layer and/or the bipolar plate, generally is an electrically conductive sinterable material powder such as a sinterable metal powder. After debinding and sintering, an electrically conductive solid structure made of the electrically conductive sinterable material is obtained.

The expression “sinterable metal powder” is intended to encompass pulverulent metal compounds which during sintering are convertible into an elemental metal. Metal compounds convertible into an elemental metal include metal hydrides such as titanium hydride, which are converted into metals during sintering under the elimination of hydrogen.

In an embodiment, the material of the porous layer and/or the supporting layer and/or the bipolar plate is metal and selected from iron, stainless steel, steel, copper, bronze, aluminum, tungsten, molybdenum, silver, gold, platinum, titanium, nickel, cobalt, chromium, zinc, niobium, tantalum, yttrium, silicon, magnesium, calcium and combinations thereof. Suitably, the metal particles have a particle size distribution such that at least 85%, preferably at least 90%, more preferably at least 95%, most preferably at least 99% of the particles have a maximum particle size Amax in the range of from 500 nm to 400 μm, preferably 1 μm to 150 μm, more preferably 3 μm to 50 μm, most preferably 5 μm to 25 μm.

Suitably, alloys are selected from steels such as stainless steels (316 L, 17-4 PH), chromium-nickel steels, bronzes, copper alloys such as Hovadur, nickel-base alloys such as Hastelloy or Inconel, cobalt and cobalt-chromium alloys such as stellite, aluminum alloys such as Aluminum 6061, tungsten heavy alloys, titanium alloys such as grade 1 via grade 5 (Ti-6Al-4V) to grade 38 according to ASTM.

In an embodiment, the material of the porous layer and/or the supporting layer and/or the bipolar plate is ceramic and selected from oxides such as aluminum oxides, silicon oxides, zirconium oxides, titanium oxides, magnesium oxides, yttrium oxides; carbides such as silicon carbides, tungsten carbides; nitrides such as boron nitrides, silicon nitrides, aluminum nitrides; silicates such as steatite, cordierite, mullite; hydrides such as titanium hydride; and combinations thereof. Suitably, the ceramic particles have a particle size distribution such that at least 85%, preferably at least 90%, more preferably at least 95%, most preferably at least 99% of the particles have a maximum particle size Amax in the range of from 200 nm to 25 μm, preferably 300 nm to 10 μm, more preferably 400 nm to 7 μm, most preferably 500 nm to 3 μm.

In an embodiment, the material of the porous layer and/or the supporting layer and/or the bipolar plate is vitreous materials and selected from non-oxide glasses such as halogenide glasses, chalcogenide glasses; oxide glasses such as phosphate glasses, borate glasses, silicate glasses such as aluminosilicate glasses, lead silicate glasses, boron silicate glasses, soda lime silicate glasses, quartz glasses, alkaline silicate glasses; and combinations thereof. Suitably, the vitreous particles have a particle size distribution such that at least 85%, preferably at least 90%, more preferably at least 95%, most preferably at least 99% of the particles have a maximum particle size Amax in the range of from 200 nm to 25 μm, preferably 300 nm to 10 μm, more preferably 400 nm to 7 μm, most preferably 500 nm to 3 μm.

In an embodiment, the material of the porous layer and/or the supporting layer and/or the bipolar plate is carbon.

Suitably, the sinterable non-organic particles (a) may contain combinations of more than one of metals, alloys, vitreous particles and ceramic particles as described above, for example hard metals or metal matrix composites (also referred to as metal ceramic composites).

Generally, the sinterable material powder has a particle size d₉₀ of 200 μm or less, preferably 180 μm or less, more preferably 150 μm or less, most preferably 120 μm or less, in particular 100 μm or less, in particular 80 μm or less, in particular 50 μm or less, in particular 25 μm or less. Typically, the material powder has a particle size d₉₀ of 0.1 μm or larger, or 1.0 μm or larger, or 5.0 μm or larger. The d₉₀ value means that 90 vol.-% of the total particles are smaller than this value. Suitably, particle size d₉₀ is determined by a laser diffraction type particle size distribution meter.

Compound particles useful in the methods above may contains the sinterable material powder in an amount of about 20 to 90% by volume, preferably 30 to 80% by volume, more preferably 40 to 75% by volume, most preferably 45 to 70% by volume, in particular 50 to 65% by volume, and the binder in an amount of about 10 to 80% by volume, preferably 20 to 70% by volume, more preferably 25 to 60% by volume, most preferably 30 to 55% by volume, in particular 35 to 50% by volume.

Each compound particle comprises a plurality of sinterable material powder particles dispersed throughout the compound particle within a matrix of the binder and is held together by the binder. A plurality of sinterable material powder particles per compound particle makes it possible for the shape of the compound particle to be independent of the shape of the sinterable material powder. Thus, for example, substantially spherical compound particles can be produced without the necessity of the sinterable material powder particles being spherical. This reduces the production costs since sinterable material powders with arbitrary or irregular particle geometry or broader particle size distribution are more readily available than powders having a particular, e.g., spherical, particle geometry.

### Binder

For additive manufacturing processes, preferably which include melting the binder, the binder may be selected from thermoplastic or wax-type materials or combinations thereof. The thermoplastic and/or wax-type material may be selected from a variety of materials.

Suitable polymers include:
vinyl ester polymers such as ethylene vinyl acetate copolymers such as Escorene® UltraUL 8705 (available from Exxon Mobile), ELVAX® 250 (available from Dow) VISCOWAX®334, VISCOWAX®453 (available from Innospec Leuna); polyolefins such as polyethylene such as Lupolen 2420, Lupolen 5261 Z (available from LyondellBasell Industries Holdings B.V.), Sabic P6006NA (available from Sabic), BorPure® MB5569, BorPure® MB6561, BorPure® MB7541 (available from Borealis), Exceed®1018, Enable®2203MC (available from Exxon Mobile), polypropylene such as BC250MO, BC545MO (available from Borealis), Adstif HA5029, Adstif HA600U, Adstif EA600P, Adstif EA648P, Clyrell RC213M, Clyrell RC5056, Hostalen PP H5416 (available from LyondellBasell Industries Holdings B.V.), Achieve® Advanced PP6936G2, Achieve® Advanced PP6945G1, Achieve® Advanced PP6035G1, ExxonMobil® PP1105E1, ExxonMobil® PP3155E5, ExxonMobil® PP9574E6 (available from Exxon Mobile), propylene-ethylene copolymers such as Vistamaxx 8880 (available from Exxon Mobile), modified polyolefins such as grafted polypropylene Licocene® PP MA 1332 (available from Clariant); acrylates such as polymethylmethacrylate (PMMA), ethylene n-butyl acrylate copolymer such as EnBA EN 33091 (available from Exxon Mobile); polyamides such as, polyamide 12, copolyamide such as Griltex 2439 A, Griltex 1796 A, Griltex 1500 A, Griltex D 2638A (available from EMS-CHEMIE HOLDING AG); Orgasol 3502 D (available from Arkema), UNI-REZ 2620, UNI-REZ 2638, UNI-REZ 2656, UNI-REZ 2674, UNI-REZ 2720, UNI-REZ 2291 (available at Kraton Corporation); polycarbonate, poly-α-methylstyrene, polyurethanes; water-soluble or water-dispersible thermoplastic polymers such as polyalkylene glycols, polyvinyl alcohols, polyvinyl lactams, polyvinylpyrrolidons, and copolymers thereof; and mixtures thereof.

The term “wax” is a collective technological term for a group of organic substances that can generally be described in terms of their physical and technical properties. In particular, waxes are characterized by the fact that they are solids with a melting point above 40° C. (usually between 50° C. and 160° C.), a low melt viscosity (below 10 Pa·s at 10° C. above the melting point). Waxes melt without decomposing. Waxes can be also divided in natural waxes of fossil origin such as paraffin, montan wax; natural waxes of natural origin such as beeswax, carnauba wax; semi-synthetic waxes (also referred to as chemically modified natural waxes) such as ethylene-bis-stearamide; synthetic waxes such as polyolefin waxes. In the context of this patent application, the expression “wax-type materials” is intended to include waxes as well as wax-type substances such as ester-type waxes, higher alcohols, higher fatty acids showing wax-like properties.

Suitable wax-type materials include:
paraffin waxes such as microcrystalline wax; ester-type waxes such as beeswax, candelilla wax, carnauba wax, esters of carboxylic acids, preferably of fatty acids having 10 to 34 carbon atoms or esters of a hydroxybenzoic acid; amide waxes such as amides of fatty acids having 10 to 25 carbon atoms such as oleamide such as Deurex A 27 P (available from Deurex AG), erucamide such as Deurex A 26 P (available from Deurex AG), ethylene-bis-stearamide such as Deurex A 20 K (available from Deurex AG);
polyolefin-waxes such as polyethylene-wax such as Deurex E 06 K, Deurex E 08, Deurex E 09 K, Deurex E 10 K (available from Deurex AG), VISCOWAX®111, VISCOWAX®116, VISCOWAX®123, VISCOWAX®135 (available from Innospec Leuna); oxidized polyethylene wax such as Deurex EO 40 K, Deurex EO 42, Deurex EO 44 P, Deurex E 76 K (available from Deurex AG), VISCOWAX®252, VISCOWAX®262, VISCOWAX®271, VISCOWAX® 2628 (available from Innospec Leuna), polypropylene-wax such as Deurex P 36 K, Deurex P 37 K (available from Deurex AG), oxidized polypropylene wax; Fischer-Tropsch wax such as VESTOWAX EH 100, VESTOWAX H 2050 MG, VESTOWAX SH 105, Shell GTL Sarawax SX 105, Shell GTL Sarawax SX 80 (available from Evonik Industries AG); polyethylene glycol; and mixtures thereof.

Preferably, the binder comprises a first thermoplastic and/or wax-type material (b-i) and the second thermoplastic and/or wax-type material (b-ii) which differ in at least one property which property is selected from solubility in a solvent, degradability induced by heat and/or a reactant, and volatility. In the event that the binder component ingredients (b-i) and (b-ii) differ in their solubility in a solvent and the first thermoplastic and/or wax-type material (b-i) is less soluble than the second thermoplastic and/or wax-type material (b-ii), debinding is carried out as a solvent debinding step using a suitable solvent. In other words, during solvent debinding, at least a part of the second thermoplastic and/or wax-type material (b-ii) is dissolved in a suitable solvent, whereas the majority of the first thermoplastic and/or wax-type material (b-i) remains within the green part.

The binder component may comprise 3 to 70% by volume, preferably 5 to 60% by volume, more preferably 7 to 50% by volume, most preferably 10 to 40% by volume, in particular 12 to 35% by volume, in particular 15 to 30% by volume, of the first thermoplastic and/or wax-type material (b-i), based on the total volume of the binder component.

The binder component may further comprise 30 to 97% by volume, preferably 40 to 95% by volume, more preferably 50 to 93% by volume, most preferably 60 to 90% by volume, in particular 65 to 88% by volume, in particular 70 to 85% by volume, of a second thermoplastic and/or wax-type material (b-ii), based on the total volume of the binder component.

Different solubility or degradability or different volatility allows for selective debinding. In the selective debinding step, one binder component is removed (in the context of the present patent application: the second thermoplastic and/or wax-type material (b-ii)) wherein at the same time another binder component (the first thermoplastic and/or wax-type material (b-i)) remains within the part to be manufactured, holding together the sinterable non-organic particles. The green parts from which the binder has been partially removed, e.g. from which the second thermoplastic and/or wax-type material (b-ii)) has been removed, are referred herein to as “(at least) partially debound green parts”. Such debinding processes, e.g. solvent debinding, thermal debinding, chemical debinding etc., are known per se.

Suitably, in the solvent debinding process, one binder component may be selectively removed from a green part by means of dissolving said binder component in a solvent, wherein a second binder component remains within the green part. Therefore, the binder components need to differ in e.g. molecular weight or polarity in order to exhibit different solubilities in the solvent.

Any given polymer or wax may be fairly soluble in one solvent, e.g., a non-polar solvent, and may be poorly soluble or insoluble in another solvent, e.g., a more polar solvent. Hence, whether a given polymer or wax qualifies as a (b-i) or (b-ii) material depends on the solvent intended for the debinding step. When changing solvents, e.g. from polar solvents to less polar or non-polar solvents or vice versa, the categorization of the binder components into (b-i) or (b-ii) may be reversed.

For additive manufacturing processes using a solvent, e.g. to form a slurry for extrusion based additive manufacturing process or mold slurry deposition, or using particles in binderjetting, the binder may be small molecular species or a short chain and may be selected from polyacrylates, sugars, sugar alcohols, polymeric or oligomeric sugars, polycarboxylic acids, polysulfonic acids, water soluble polymers containing carboxylic or sulfonic moieties, polyvinyl alcohol, polyethers, polyvinylpyrrolidone, polyether alkoxy silane, and combinations thereof. Some specific examples include glucose maltodextrines with a chain length ranging from 2 to 20 units, sorbitol (C₆H₁₄O₆), erythritol (C₄H₁₀O₄), mannitol (C₆H₁₄O₆), a polyethylene glycol and/or a co-polymer thereof, a polypropylene glycol and/or a co-polymer thereof, or CARBOSPERSE® K7028 (a short chain polyacrylic acid, M˜2,300 Da, available from Lubrizol). Low or moderate molecular weight polycarboxylic acids (e.g., having a molecular weight less than 5,000 Da) may dissolve relatively fast. It is to be understood that higher molecular weight polycarboxylic acids (e.g., having a molecular weight greater than 5,000 Da up to 10,000 Da) may be used, however the dissolution kinetics may be slower. In an embodiment, the temporary binder is selected from the group consisting of polyacrylates, sugars, sugar alcohols, polymeric or oligomeric sugars, polyacrylate, polycarboxylic acids, polysulfonic acids, water soluble polymers containing carboxylic or sulfonic moieties, polyethers, polyvinylpyrrolidone, polyether alkoxy silane, and combinations thereof.

For additive manufacturing processes using lithography based technologies the resin or paste may be a photo polymerizable polymer.

### Sintering Step

The process further comprises the step of sintering the brown part to obtain a sintered part. For this purpose, the brown part is suitably subjected to a sintering step after the debinding step. During the sintering step, the first thermoplastic and/or wax-type material (b-i) is removed and the debound part (brown part) is sintered to obtain the sintered part. Generally, on further removal of the binder and the subsequent sintering of the brown part, shrinkage occurs.

Suitably, the residual binder is driven out at a first temperature which is in the range of from 100 to 750° C., preferably 150 to 700° C., more preferably 200 to 650° C., most preferably 250 to 600° C.

The sinterable material powder particles partly form sintering necks, so that the part is held together despite removal of the remaining binder components. Owing to the microporous structure of the part, thermal binder removal occurs quickly and uniformly.

Undesirable chemical reactions during the thermal binder removal may be avoided by means of an inert gas atmosphere or a reducing atmosphere or high vacuum. The inert gas atmosphere comprises, in particular, at least one noble gas which noble gas may suitably be selected from, e.g., nitrogen, helium and argon. The reducing atmosphere may include gases such as hydrogen, carbon dioxide, and/or carbon monoxide. The high vacuum may include a pressure of at least 10⁻² Pa or less, preferably at least 10⁻³ Pa or less, more preferably at least 10⁻⁴ Pa or less, most preferably at least 10⁻⁵ Pa or less.

Suitably, sintering is carried out at a second temperature which is in the range of from 600 to 2000° C., preferably 800 to 1800° C., more preferably 900 to 1500° C. In any case, the second sintering temperature is below the melting temperature of the sinterable material powder particles.

By reducing the sintering temperature, fully dense sintering is avoided and a higher degree of sintering porosity can be obtained.

During this sintering step, the molded part will shrink essentially without affecting the shape of the molded part. The powder particles will fuse together and the open space between the powder particles reduces or disappears. Hence, during sintering, the density of the product increases and the product shrinks. The density of the sintered part is depending on the particle size of the sinterable material and the sintering conditions and can be tailored to the specific needs of the part.

Preferably, after the sintering step, the part is completely free of binder. As a result, the part forms an integral structure of high density or a porous structure.

In Röttger, Boes, et al., The International Journal of Advanced Manufacturing Technology 2020, 108, 769-783, the microstructure for 316L in SLM processes is described. On the mesoscale, the microstructure is characterized by a layer-wise morphology.

It is an advantage of the process and the element of the present invention that an isotropic microstructure and a part without tension is obtained. On the mesoscale, the microstructure is characterized by an equiaxed, uniform morphology and no layer-wise structures in the microstructure are obtained. The grain structure does not show a preferential direction.

In an embodiment, the vicinity of the joints where different parts, e.g. the porous layer and the supporting layer or the supporting layer and the bipolar plate, are thermally bonded, exhibits essentially the same microstructure as the bulk region. For example, in a region within up to 0.5 mm, preferably 1 mm, more preferably 2 mm, most preferably 3 mm from the joint, e.g. a bonding line or a bonding point, the microstructure is essentially the same. “Essentially the same microstructure” is intended to mean that the grain structure does not change, has no gradient and has the same grain size.

For example, the microstructure for austenitic steels such as stainless steel 316L is characterised by twins and equiaxed grain structure, with an average grain size ranging from 1 μm to 100 μm, preferable from 3 μm to 80 μm, more preferably from 5 μm to 60 μm, most preferably from 8 μm to 40 μm, in particular from 10 μm to 30 μm. Existing closed pores in the microstructure usually are very small and rounded with an average diameter of 0.5 μm to 5 μm, and are located preferentially within the grains and not on the grain boundaries.

For example, the microstructure for titanium alloys with a (α+β) structure such as Ti6Al4 is characterised by lamellar (a+β) structure with a β-grain size of approximately 150 to 250 μm produced at sintering temperatures of approximately 1100 to 1400° C. with a sintering duration of approximately 2 to 5 h.

Using material powder of titanium alloys with a (α+β) structure such as Ti6Al4 and sintering temperatures around 1000° C. lead to a bimodal structure which is composed of a globular α-structure and small amounts of lamellar (a+β)-structure with a mean β-grain size around 50 to 100 μm.

Using material powder of titanium alloys with a (α+β) structure such as Ti6Al4 and sintering temperatures around 950° C. lead to a globular structure with an average α-grain size of 8 to 15 μm and a maximum size of 20 to 40 μm.

For example, the microstructure for sintered commercially pure (CP) Titanium is characterised by isotropic and uniformly distributed predominately globular alpha grains to a small amount of bimodal microstructure.

Sintering of Commercially Pure (CP) Titanium does not lead to as clearly identified grains boundaries compared to (α+β)-alloys. Grain boundaries can be identified after polishing and etching with Krolls or similar reagent and the use of polarised light microscopy. Electron Backscatter Diffraction (EBSD) can identify the crystal structure, crystal orientation and grain boundaries.

A sintering temperature of 1000 to 1400° C. leads to isotropic and uniformly distributed predominately globular alpha grains with a grain size of 75 to 500 μm.

A sintering temperature of 850 to 1000° C. leads to isotropic and uniformly distributed predominately globular alpha grains with a grain size of 40 to 100 μm.

A sintering temperature of below the beta transus of around 850° C. leads to isotropic and uniformly distributed predominately globular alpha grains with a grain size of below 50 μm. The microstructure of the rapidly cooled Titanium powder itself may be observed due to the fact that sintering temperatures significantly below the beta transus may not significantly influence the original powder microstructure.

### Aftertreatments

The surface of the porous metal layer opposite the supporting layer can be subjected to various aftertreatments. Hence, the surface of the porous metal layer opposite the supporting layer may be treated by a smoothening process and/or a roughening process. A roughening treatment such as etching or blasting may serve to improve the adhesion of a catalyst coating applied to the porous metal layer. A smoothening process such as polishing may serve to prevent damage to the PEM, once the porous metal layer is brought into intimate contact with the PEM. Also, the treatments may serve to remove unwanted superficial metal oxide films from the surface of the porous metal layer.

Finally, the porous metal layer at least in partial regions may be provided with a catalytic layer and/or a catalytic coating, preferably of nickel, platinum, gold, iridium or iridium oxide.

The invention also relates to a device useful in filtration, chemical processes or electrochemical processes comprising a porous layer and a supporting layer obtainable by the process of the invention.

The invention also relates to an electrode useful in an electrolyzer, preferably a PEM-type electrolyzer, in a fuel cell, in a power-to-liquid reactor, in a gas-to-liquid reactor or in a power-to-gas reactor, comprising a porous metal layer, a supporting layer and a bipolar plate obtainable by the process of the invention.

Preferably, the device or electrode are characterized by a sintered structure of both the porous layer and supporting layer, with joints between the porous layer and supporting layer formed by a sintered connection. The joint formed by sintering is based on metal inter-diffusion at an enhanced surface area of the micrometer-sized metal particles.

The invention is further illustrated by the accompanying drawings.

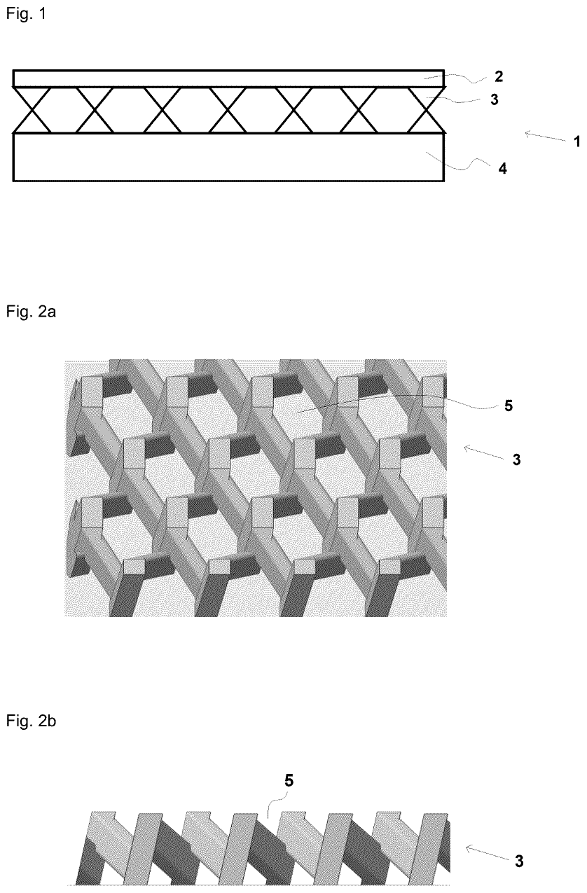

FIG. 1 is a schematic cross-section of one embodiment of the device of the invention.

FIGS. 2 to 8 show embodiments of the supporting layer.

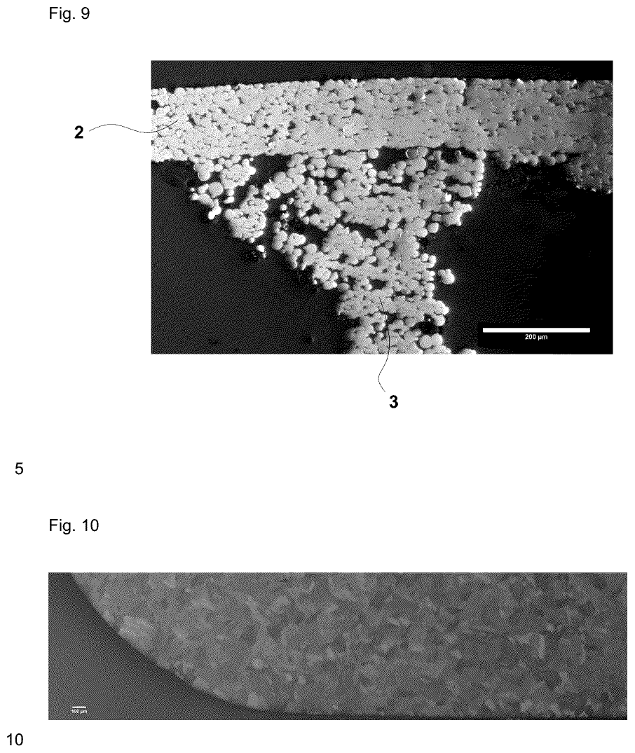

FIG. 9 shows a microscopic view of a cross-section of a joining portion of the porous metal layer and a grid web of the supporting layer.

FIG. 10 shows a microscopic view of the microstructure of commercially pure (CP) Titanium.

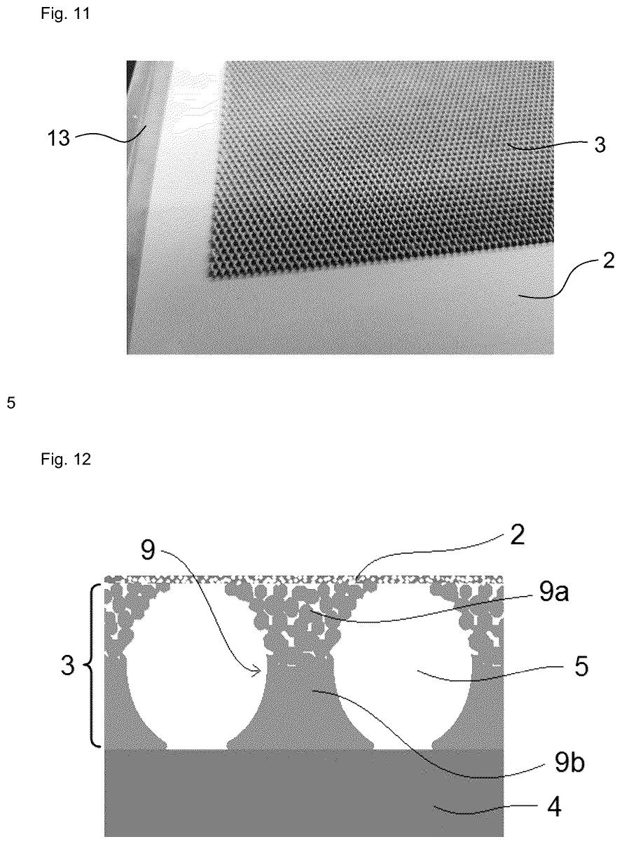

FIG. 11 depicts a green part of a supporting layer printed on a green part of a porous layer.

FIG. 12 depicts a cross section of an assembly of a bipolar plate, a supporting layer and a porous metal layer.

With regard to FIG. 1, the device 1 comprises a porous metal layer 2, a supporting layer 3 and a bipolar plate 4.

With regard to FIG. 2, the supporting layer 3 has a generally grid-like structure with grid webs and grid nodes. The grid webs are tilted with respect to the plane P of the supporting layer 3 to form passageways 5 between the grid webs and the underneath surface.

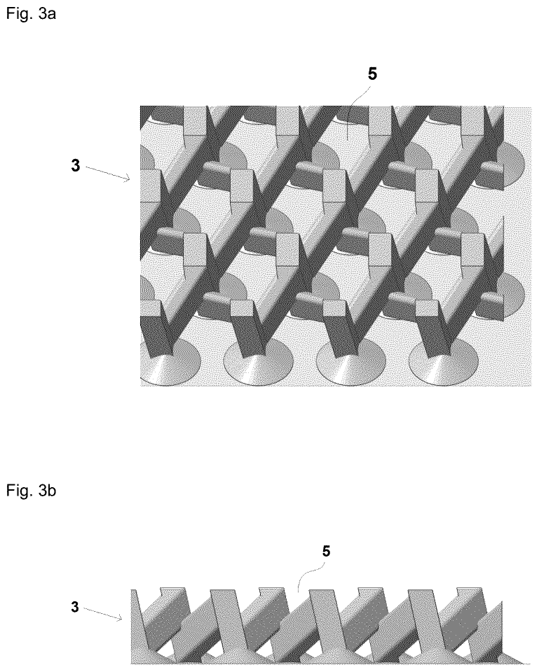

FIG. 3 shows a modification of the supporting layer 3 of FIG. 2. At the points of contact with the underneath porous metal layer, the grid has conical or trumpet-shaped widenings. The widenings enhance the contact and thus the electrical conductivity with the porous metal layer 2 as well as the mechanical stability of the part.

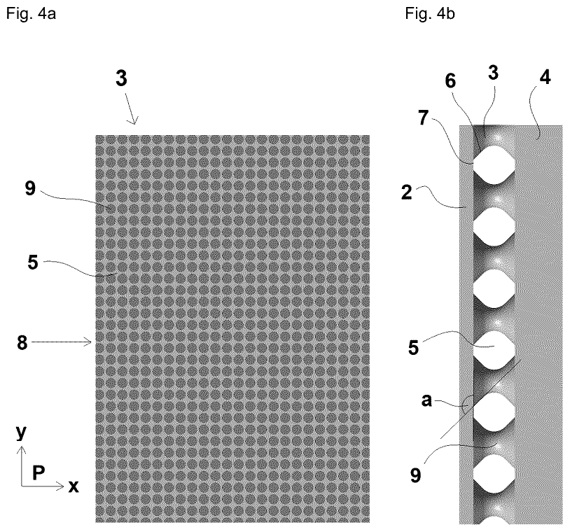

FIG. 4a shows the top view of an embodiment of the supporting layer 3. Circles illustrate the contacting surface of hourglass-shaped columns 9 with the porous metal layer 2. Passageways 5 are formed between the hourglass-shaped columns 9 and allow for flow of the reactants and reaction products through the supporting layer 3 from one side face 8 of the supporting layer 3 to an opposite side face of the supporting layer 3.

FIG. 4b shows a cross-section of the electrode comprising the porous metal layer 2, the supporting layer 3 and the bipolar plate 4. The supporting layer 3 comprises hourglass-shaped columns 9 having an axis being perpendicular to the plane P of the supporting layer 3. Passageways 5 are formed between the hourglass-shaped columns 9. The passageways 5 are open towards surface 7 of the porous metal layer 2. A tangent on the surface 6 of the supporting layer 3 forming the passageway 5 being close to the surface 7 of the porous metal layer 2 forming the passageway 5 makes an angle a with said surface 7 of the porous metal layer 2 that is 135°.

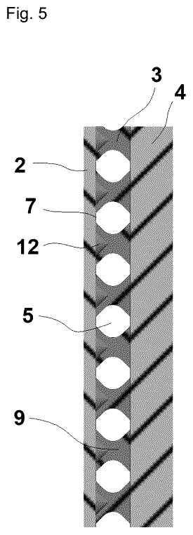

FIG. 5 shows a modification of the embodiment of FIG. 4a and FIG. 4b. In the hourglass-shaped columns 9, central recesses in the form of conical closed cavities 12 are formed. The closed cavities 12 are limited by the hourglass-shaped column 9 and the porous metal layer 2.

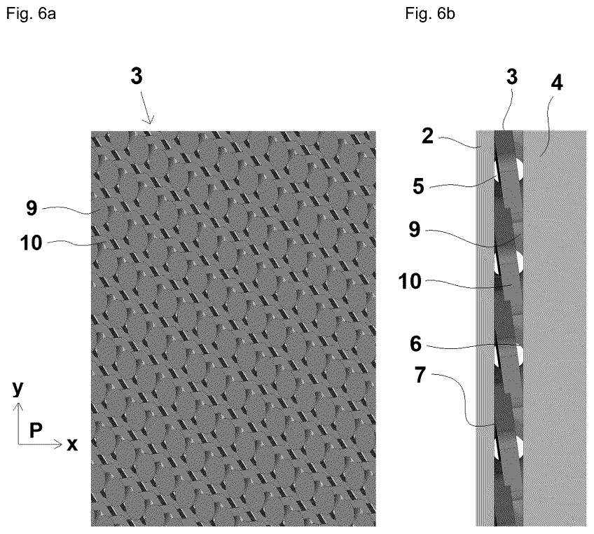

FIG. 6a shows the top view of another embodiment. Circles illustrate the contacting surface of hourglass-shaped columns 9 with the porous metal layer 2. The hourglass-shaped columns 9 are interconnected by connecting braces 10 which are arranged crosswise.

With regard to FIG. 6b, the connecting braces 10 are tilted with respect to the plane of the supporting layer 3.

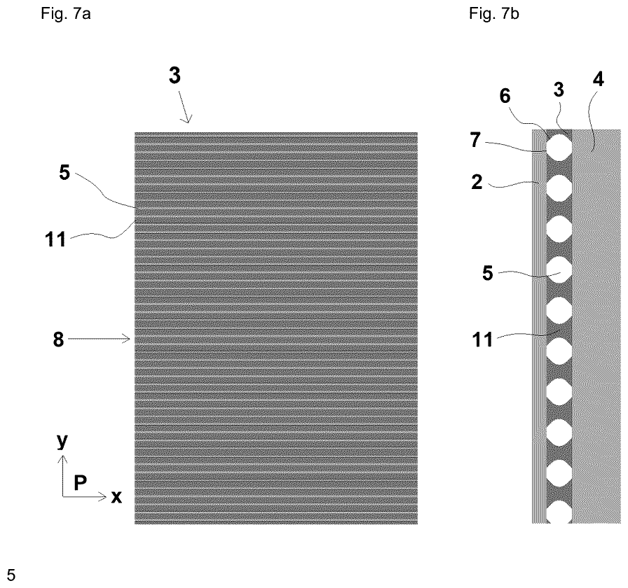

FIG. 7a shows the top view of another embodiment. The supporting layer 3 comprises parallel ribs 11 spaced from each other so that straight channels 5 are formed. Each of said channels 5 has a first opening at the side face 8 of the supporting layer 3 and a second opening at the opposite side face of the supporting layer 3.

With respect to FIG. 7b, the channels 5 are confined by the ribs 11, the bipolar plate 4 and the porous metal layer 2. The flow cross section of the channel 5 is essentially round.

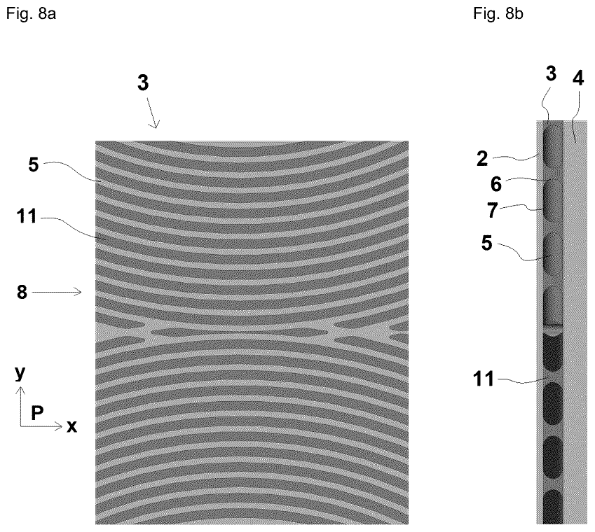

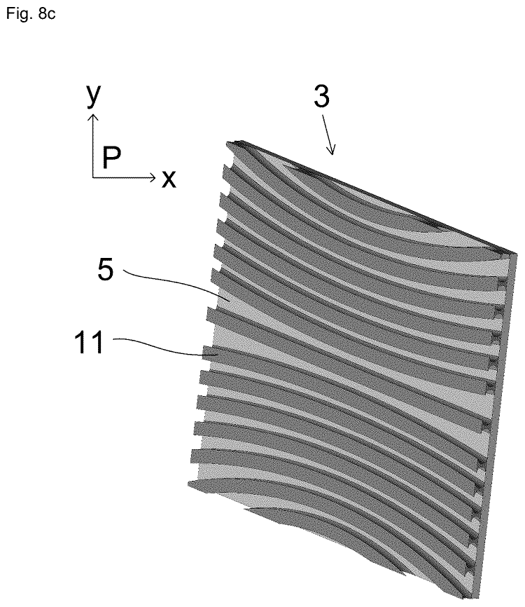

FIGS. 8a and 8b show a modification of the embodiments of FIGS. 7a and 7b, except that the channels 5 are single-curved.

FIG. 8c shows an embodiment of the supporting layer 3 having a non-uniform geometrical porosity in a direction parallel to the plane P of the supporting layer 3.

The supporting layer 3 has ribs 11 which are spaced at a greater distance at the left and right lateral portions of the supporting layer 3 meaning that the passageways 5 have a greater cross section in the left and right lateral portions than in the middle portion.

FIG. 9 shows the sintered structure of the porous metal layer 2 and a grid web of the supporting layer 3. The joint between the porous metal layer 2 and supporting layer 3 is formed by a sintered connection.

FIG. 10 shows, by way of reference, a microscopic view of the microstructure of commercially pure (CP) Titanium under polarized light. Sintering has been carried out at a sintering temperature of 990° C. The microstructure is characterised by isotropic and uniformly distributed predominately globular alpha grains.

FIG. 11 depicts a green part of a porous layer 2 produced by a casting process which was fixed by fixation means 13 (adhesive tape) on a support and placed in a 3D-printing chamber. Subsequently, a green part of a supporting layer 3 was printed on the green part of the porous layer 2.

FIG. 12 depicts a cross section of an assembly of a bipolar plate 4, a supporting layer 3 and a porous metal layer 2. The supporting layer 3 is constituted of hourglass-shaped columns 9 having a high sintering porosity portion 9a facing the porous metal layer 2, and a relatively dense portion 9b having little or no sintering porosity.

### PRODUCTION EXAMPLES

Binder component 1-B was produced according to table 1. Feedstock compound 1-F of binder component 1-B was produced according to table 2.

TABLE 1
Binder component 1-B; vol.-% relative the
total volume of the binder component (b).

| | material | (b-i) | material | (b-ii) |
|---|---|---|---|---|
| # | (b-i) | [vol.-%] | (b-ii) | [vol.-%] |
| 1-B | Griltex | 27 | Loxiol 2472 ^{[2]} | 69 |
| | 2439 A ^{[1]} | | Loxiol G20 ^{[3]} | 4 |

^{[1]} copolyamide having a DSC melting range of 115 to 125° C., available from EMS-CHEMIE HOLDING AG
^{[2]} 4-hydroxybenzoic behenylester available from Emery Oleochemicals GmbH
^{[3]} stearic acid available from Emery Oleochemicals GmbH

TABLE 2
Feedstock compound 1-F; vol.-% relative the total
volume of the particulate feedstock compound.

| | | amount (a) | binder comp. (b) | amount (b) |
|---|---|---|---|---|
| # | metal (a) | [vol.-%] | (# in table 1) | [vol.-%] |
| 1-F | Titanium grade 2 ^{[1]} | 62 | 1-B | 38 |

^{[1]} gas atomized, particle size 0 to 45 μm, available from AP&C.

### Laser Additive Manufacturing

Supporting layers as shown in FIGS. 2 and 3 were produced by laser additive manufacturing using computer files generated by computer-aided design (CAD) device.

Supporting layer structures were produced by a laser additive manufacturing process using a Formiga P110 (available from EOS GmbH). The feedstock compound 1-F of table 2 was used as starting material.

For the supporting layer structures, the hatch distance was 0.13 mm at a laser speed of 2500 mm/s and the powder bed surface temperature was 50° C. the laser output of 20 W resulted in an energy input of 61.5 mJ/mm².

### Manufacture of Sintered Parts

Said supporting layer structures were then subjected to a solvent debinding step and a sintering step. For solvent debinding, the green parts were dipped into acetone at a temperature of 45° C. for 16 h. Sintering was carried out in a cycle with a heating and cooling rate of 5 K/min, holding times of 2 h at 380° C., of 1 h at 600° C. and of 2 h at a final sintering temperature of 900° C. in an argon atmosphere.

### LIST OF REFERENCE SIGNS

1 device
2 porous metal layer
3 supporting layer
4 bipolar plate
5 passageway
6 surface of the supporting layer 3
7 surface of the porous metal layer 2
8 side face of the supporting layer 3
9 hourglass-shaped columns
10 connecting braces
11 rib
12 closed cavity
13 fixation means
a angle between the passageway 5 and the surface 7
P plane of the supporting layer 3

1. A process for producing a device for use in filtration, chemical processes or electrochemical processes comprising a porous layer (2) and a supporting layer (3) comprising channels running in the plane (P) of the supporting layer (3) and being open towards the porous layer (2), the process comprising
providing a stack comprising
a) the porous layer (2), or a green part of the porous layer (2) which green part contains a sinterable material powder and a binder, or a partially debound green part of the porous layer (2), and
b) A green part of the supporting layer (3),
the green part of the supporting layer (3) being applied on the porous layer (2) or the green part of the porous layer (2) or the partially debound green part of the porous layer (2) by additive manufacturing from a sinterable material powder and a binder in a layer-by-layer wise manner,
sintering the green parts, and
thermally bonding the stack.

2. The process according to claim 1, wherein the device is an electrode useful in an electrolyzer, in a fuel cell, in a power-to-liquid reactor, in a gas-to-liquid reactor or in a power-to-gas reactor, wherein the porous layer (2) is a porous metal layer (2), the device additionally comprising a bipolar plate (4) facing the surface (6) of the supporting layer (3) opposite the porous metal layer (2), the stack additionally comprising
c) the bipolar plate (4), or a green part of the bipolar plate (4) which green part contains a metal powder and a binder.

3. The process according to claim 2, wherein the bipolar plate (4) comprises channels running in the plane (P) of the bipolar plate (4) and being open towards the porous layer (2).

4. The process according to claim 1, wherein the green part of the porous layer (2) is formed into a sheet-like shape by an extrusion process, a layer-by-layer wise manner process, a casting process, or a calendering process.

5. The process according to claim 1, wherein the thickness of the porous layer (2) is in the range of from 0.01 to 2 mm and/or
the thickness of the supporting layer (3) is in the range of from 0.5 to 5 mm.

6. The process according to claim 2, wherein the thickness of the bipolar plate (4) is in the range of from 0.5 to 5 mm.

7. The process according to claim 2, wherein the channels have a height in a direction perpendicular to the plane (P) of the supporting layer (3) and/or the bipolar plate (4) in the range of from 0.5 to 5 mm.

8. The process according to claim 1, wherein the supporting layer (3) has a non-uniform opening ratio in a direction perpendicular to the plane (P) of the supporting layer (3).

9. The process according to claim 1, wherein the supporting layer (3) has a non-uniform geometrical porosity in at least one direction parallel to the plane (P) of the supporting layer (3).

10. The process of claim 9, wherein the supporting layer (3) is substantially ordered in one direction or two directions parallel to the plane (P) of the supporting layer (3) by at least a part of the layer, but the order has a gradient in one direction or two directions parallel to the plane (P) of the supporting layer (3).

11. The process according to claim 1, wherein the geometrical porosity of the porous layer (2) is in the range of from 30 to 80 vol.-%.

12. The process according to claim 1, wherein the surface (7) of the porous layer (2) opposite the supporting layer (3) is treated by a smoothening process and/or a roughening process.

13. The process according to claim 2, wherein the porous metal layer (2) at least in partial regions comprises a catalytic layer and/or a catalytic coating, preferably of nickel, platinum, gold, iridium or iridium oxide.

14. The process according to claim 1, wherein structural elements constituting the supporting layer (3) have a non-uniform sintering porosity in a direction perpendicular to the plane (P) of the supporting layer (3).

15. The process according to claim 2, wherein the bipolar plate (4) is fluid-tight.

16. The process according to claim 1, wherein the sinterable material powder has a particle size d₉₀ of 200 μm or less.

17. The process according to claim 2, wherein the metal of the porous metal layer (2) and/or the supporting layer (3) and/or the bipolar plate (4) is a) titanium or a titanium alloy, b) nickel or a nickel alloy, c) iron or an iron alloy, or d) carbon.

18. A device useful in filtration, chemical processes or electrochemical processes comprising a porous layer (2) and a supporting layer (3) obtained by a process of claim 1.

19. An electrode useful in an electrolyzer, in a fuel cell, in a power-to-liquid reactor, in a gas to liquid reactor or in a power to gas reactor, comprising
a porous metal layer (2), a supporting layer (3) and a bipolar plate (4) obtained by a process of claim 1.

20. The device of claim 18, characterized by a sintered structure of both the porous layer (2) and supporting layer (3), with joints between the porous layer (2) and supporting layer (3) formed by a sintered connection.
